(19) United States
(12) Patent Application Publication
(10) Pub. No.: US 2012/0241485 A1
(43) Pub. Date: Sep. 27, 2012

(54) Device and method for transporting elongate objects using pick-up truck

(76) Inventor: Kevin Moore, Glendale, AZ (US)

(21) Appl. No.: 13/065,423

(22) Filed: Mar. 22, 2011

(51) Int. Cl. B60R 9/04; B23P 19/04

(52) U.S. Cl. 224/282; 29/428

(57) ABSTRACT

A kit for securing ladders to a vehicle comprising at least two units, each unit comprising a body with a pivotally attached arm unit, wherein each unit is adapted to be secured to a portion of a ladder. Each arm unit comprises an arm body, with a pivot aperture, and two attached arms. The included angle between the two attached arms is 120°. A method for securing ladders to a vehicle comprising the steps of: providing two units, each unit comprising a body with a pivotally attached arm unit; attaching the two units to opposite sides of a ladder; placing the ladder in the bed of a pick-up such that the pivotally attached arm units are in contact with the cab of the pick-up; and securing the ladder to the pick-up to prevent unwanted movement.

### FIELD OF THE INVENTION

The present invention relates generally to a device and method used in loading and transporting lengthy objects on a pick-up truck. More specifically, the present invention is a device and method for securing the lengthy objects to the pick-up truck such that they do not easily shift during transportation.

### BACKGROUND

Pick-up trucks are designed to safely transport objects of certain dimensions. However, when objects exceed these certain dimensions, they are more likely to shift in transport and even leave the vehicle. This usually occurs when the object is lengthy and has been propped against either the cab or the tailgate of the pickup truck. Examples are found in the transport of ladders, long boards, poles, and other lengthy objects.

Indeed, anyone who has traveled on the highways of an urban area has seen where improperly secured objects, such as ladders, boards and the like, have fallen out of a transporting vehicle and partially, or completely, obstruct the roadway. These are very dangerous situations.

The prior art shows numerous different attempts to address this and other needs. One commonly found solution is a rack that is mounted to the pick-up bed. The rack may or may not include a portion that overhangs the cab of the truck. While this aids in the transport of lengthy objects, it still relies upon the user to properly secure the objects to the rack. Also, for aesthetic and other reasons many vehicle owners will not mount a rack onto the bed of their truck. An example of this type of prior art device is fund in U.S. Pat. No. 5,067,644, issued to Coleman. This patent discloses a load carrying rack that is mounted onto a vehicle roof. The rack includes straps for securing the load to the rack device. Another example of this type of prior art device is illustrated in the drawings contained in U.S. Pat. No. 5,553,760 issued to Wright, et al. Yet another example is found in U.S. Pat. No. 3,884,404, issued to Frost.

Another prior art device is a multi-piece racking systems. An example of a multi-piece rack is found in U.S. Pat. No. 4,630,990, issued to Whiting. In this patent, there are two pieces to the racking system. A front piece that is mounted onto the cab of the truck, and a rear piece that is mounted onto the rear bumper of the truck. The large or long object to be transported is then placed upon the front and rear pieces. Straps are provided on each separate piece to secure the object being transported to the racking system. However, this entails the lengthy process of mounting and dismounting the separate pieces onto the truck. Further, it is a large bulky unit that is undoubtedly expensive and difficult to store. Yet another example is found in U.S. Pat. No. 3,884,404, issued to Frost.

Another type of solution has been to provide devices that are designed to protect specific portions of the truck exterior, such as the cab or the tailgate. An example of a cab protective device is found in U.S. Pat. No. 4,984,837, issued to Dise. This patent discloses a device that is mounted to a side portion of the cab, and extends over the top portion of the cab. Long objects are placed in the bed of the truck such that they extent over the cab and rest upon the device of the Dise patent. There are side arms that project upward to prevent the objects from sliding laterally off of the cab of the truck. Another example is found in U.S. Pat. No. 3,047,161, issued to Thacker. This device is a rack that mounts immediately behind the cab and projects up past the top of the cab. Long objects that extend past the cab are supported over the cab, thereby protecting the surface of the cab. Additionally, as in the Dise patent discussed above, there are portions of the rack that project up past the central portion to prevent unwanted lateral movement of the supported objects.

An example of a tailgate protecting device may be found in U.S. Pat. No. 4,389,067, issued to Rubio. This patent discloses a small rack that is mounted onto a top portion of the tailgate and that projects upward above the tailgate. Thus, objects that are placed in the bed of the truck and that extend past the tailgate rest upon the mounted rack and do not mar the surface of the tailgate. This device does not, however, address the problem of lateral movement of the supported object. Another example of a tailgate protection device may be found in U.S. Design Patent No. DES. 387,722, issued to Fujinaka. This patent illustrates a device that appears to be mountable onto a top portion of the truck tailgate and that supports transported objects. As with the Fujinaka patent above, this device does not address the problem of lateral movement of the transported object.

Finally, U.S. Pat. No. 4,957,400, issued to Karp discloses a complex system of cab and tailgate protectors used in combination with a series of straps. A cab protector is mounted onto the cab, a tailgate protector is mounted onto the tailgate and the object is supported on the two protectors. Then a series of straps are attached to the truck at a variety of points, such as strap hooks and gutters commonly found on pick-up trucks. These straps securely hold the supported object to the protective devices.

However, there is still a clear and continuing need for devices and methods that aid in the transport of lengthy objects on a pick-up truck.

### SUMMARY OF THE INVENTION

It is an object of the present invention to provide a device and method for the transport of lengthy objects on a pick-up truck.

It is another object of the present invention to provide a device and method for the transport of lengthy objects on a pick-up truck that securely holds the transported object and limits unwanted lateral movement of the transported object.

It is a further object of the present invention to provide a device and method for the transport of lengthy objects on a pick-up truck that is small and portable.

It is yet another object of the present invention to provide a small portable device for the transport of lengthy objects that is foldable for easy storage.

The novel features that are considered characteristic of the invention are set forth with particularity in the appended claims. The invention itself, however, both as to its structure and its operation together with the additional object and advantages thereof will best be understood from the following description of the preferred embodiment of the present invention when read in conjunction with the accompanying drawings. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments is not intended to indicate a desire to invoke the special provision of 35 U.S.C. §112, paragraph 6 to define the invention. To the contrary, if the provisions of 35 U.S.C. §112, paragraph 6, are sought to be invoked to define the invention(s), the claims will specifically state the phrases “means for” or “step for” and a function, without also reciting in such phrases any structure, material, or act in support of the function. Even when the claims recite a “means for” or “step for” performing a function, if they also recite any structure, material or acts in support of that means of step, then the intention is not to invoke the provisions of 35 U.S.C. §112, paragraph 6. Moreover, even if the provisions of 35 U.S.C. §112, paragraph 6, are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, materials or acts for performing the claimed function.

### BRIEF DESCRIPTION OF THE DRAWINGS

FIG. 1 is a side view illustrating the use of the present invention.

FIG. 2 illustrates a first embodiment of the present invention installed on a ladder, the inset is shown magnified.

FIG. 3 illustrates the flexibility in using the present invention.

FIG. 4 is a side view of the first embodiment of the present invention in an installed configuration. The ladder is shown crosshatched.

FIG. 5 is an exploded view of the present invention.

FIG. 6 illustrates a second embodiment of the present invention installed on a ladder, the inset is shown magnified.

FIG. 7 illustrates a second embodiment installed on a ladder. The ladder is illustrated in dashed lines.

FIG. 8 is a partial exploded view of the second embodiment of the present invention.

FIG. 9 illustrates a third embodiment of the present invention installed on a ladder, the inset is shown magnified.

FIG. 10 is a perspective view of the third embodiment of the present invention.

FIG. 11 is an exploded view of the third embodiment of the present invention.

### DESCRIPTION OF PREFERRED EMBODIMENTS

The device and method according to the present invention are useful for limiting unwanted movement of lengthy objects being transported by a pick-up truck. More specifically, the present invention helps prevent the loss of these lengthy objects during transport.

With reference to the figures, the kit according to the present invention is comprised of at least two separate units 10 that are used simultaneously on a ladder or other elongated object. Preferably each unit 10 is a duplicate of the other. To with, by describing a single unit 10 all other units are likewise described.

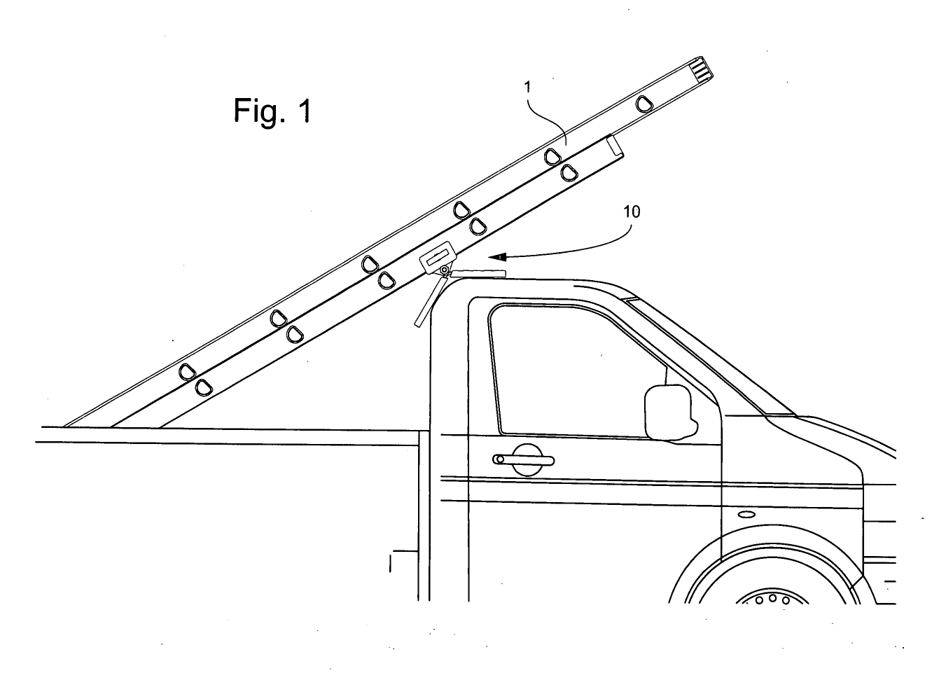

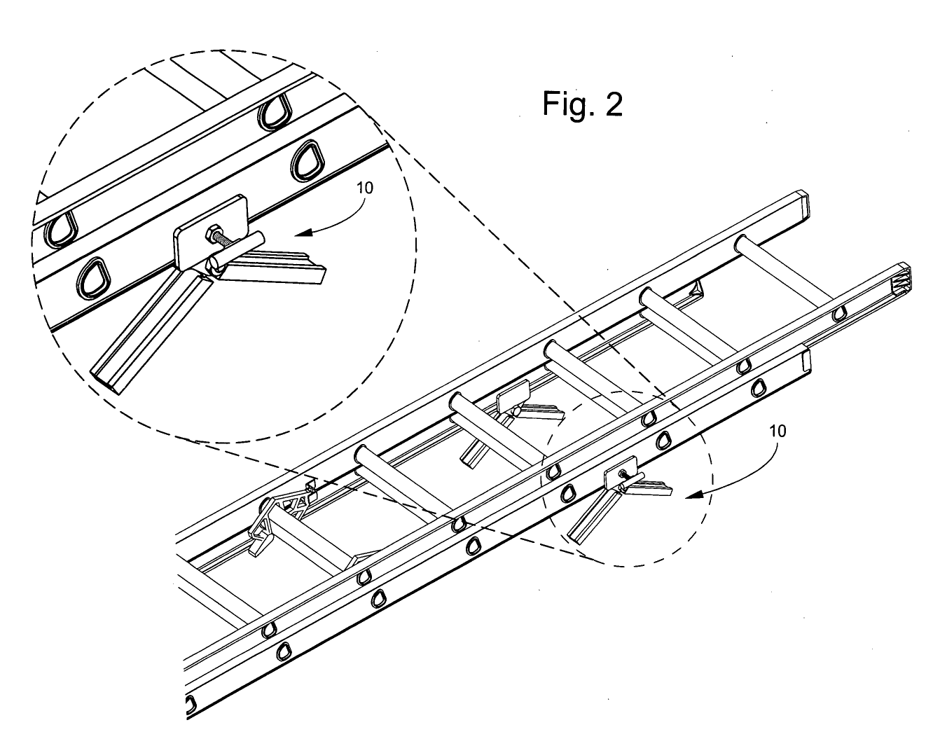

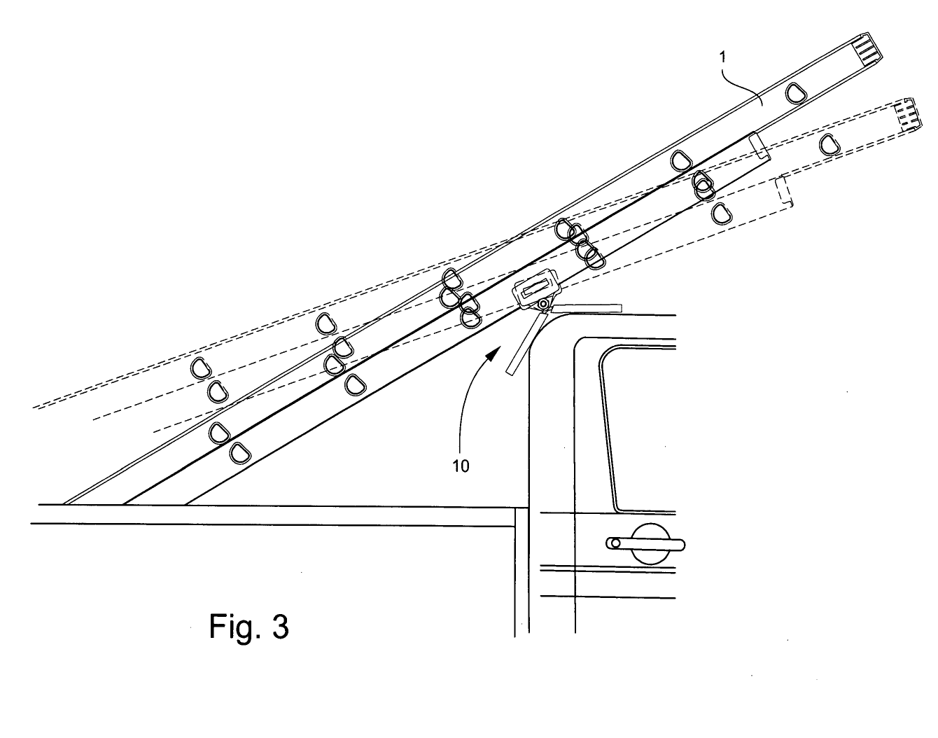

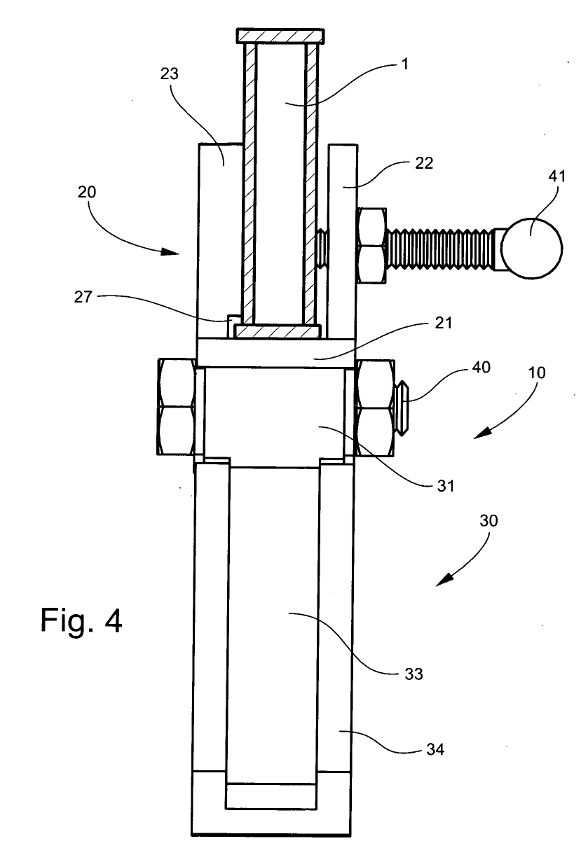

In a first embodiment, illustrated in FIGS. 1-5, each unit 10 comprises a generally U shaped body 20 with a base plate 21 and first and second generally parallel side plates, 22 and 23, respectively, attached to the base plate 21. In a preferred embodiment, there is a threaded aperture 24 located in a generally central position in the first side plate 22. The body 20 further has at least one, preferably two pivot tangs 25 that are attached to an under side of the base plate 21. Each pivot tang 25 includes a centrally located pivot tang aperture 26. In a preferred embodiment, there is a small channel 27 cut into the vertex of the base plate 21 and the second side 23. This channel 27 is sized to fit a projecting portion a leg of a ladder 1 (see FIG. 4).

Each unit 10 further includes a pivotable arm 30. Each pivotable arm 30 has an arm body 31 that includes a pivot arm aperture 32 and at least one, preferably two, arms 33. In a preferred embodiment, the included angle between two pivot arms 33 is 120°. Also, in a preferred embodiment, each arm 33 has a cushion 34 attached to a surface include in the included angle. The pivot arm body 31 is sized to fit the pivot arm aperture 32 between the pivot tangs 25 thereby allowing the pivot arm aperture 32 to line up co axially with the pivot tang aperture 26.

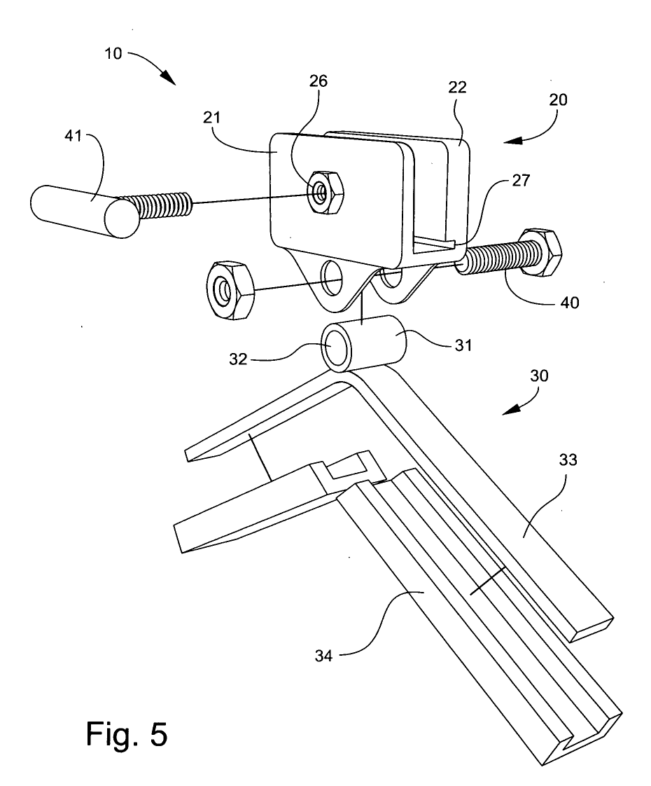

In this first embodiment there is a pivot pin 40 that inserts though the lined up pivot arm apertures 32 and pivot tang aperture 26, thereby allowing the pivotable arm 30 to rotate about the pivot pin relative to the unit body 20. In one version the pivot pin 40 is a bolt and nut combination, as is illustrated in FIG. 5, but other forms of pivot pins 40 may be used and still fall within the scope of the present invention.

Finally, there is a securing bolt, preferably a T shaped bolt 41 that threads through the threaded aperture 24 and secures a ladder leg portion that has been inserted in the space between the first and second sides 22 and 23.

In use, a segment of a ladder 1 is inserted into the gap between the first and second sides, 22 and 23 respectively; the T shaped bolt is screwed into the body 20 forcing the end of the bolt 41 against the ladder segment, thereby securing the unit 10 onto the ladder 1. If the ladder segment has a projecting rim it is allowed to slide into the channel 27 thereby preventing unwanted distortion of the ladder segment.

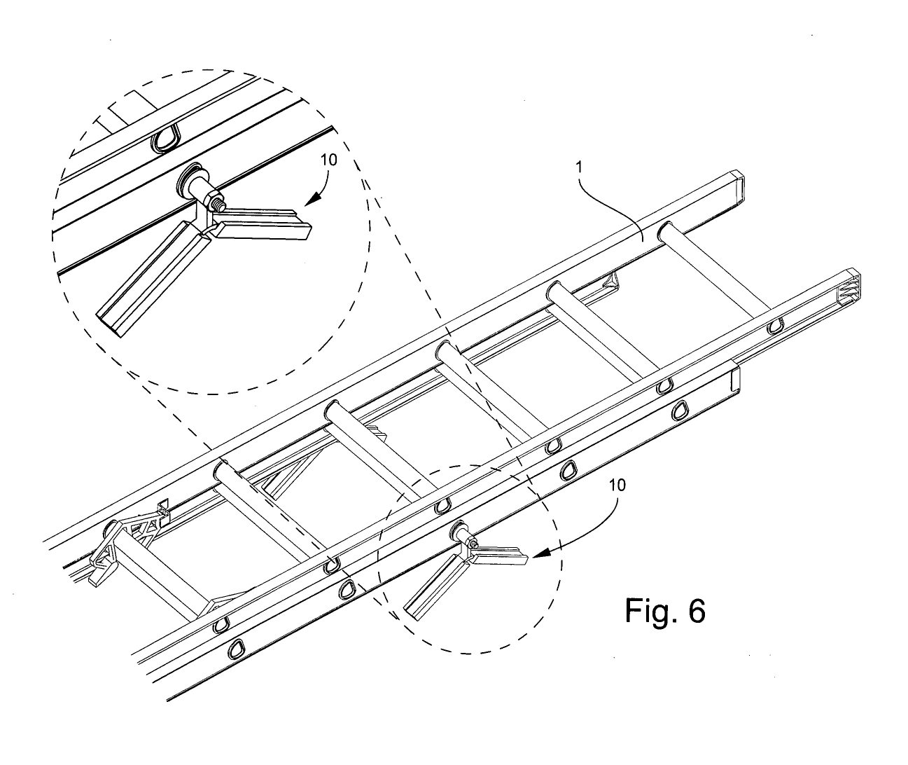

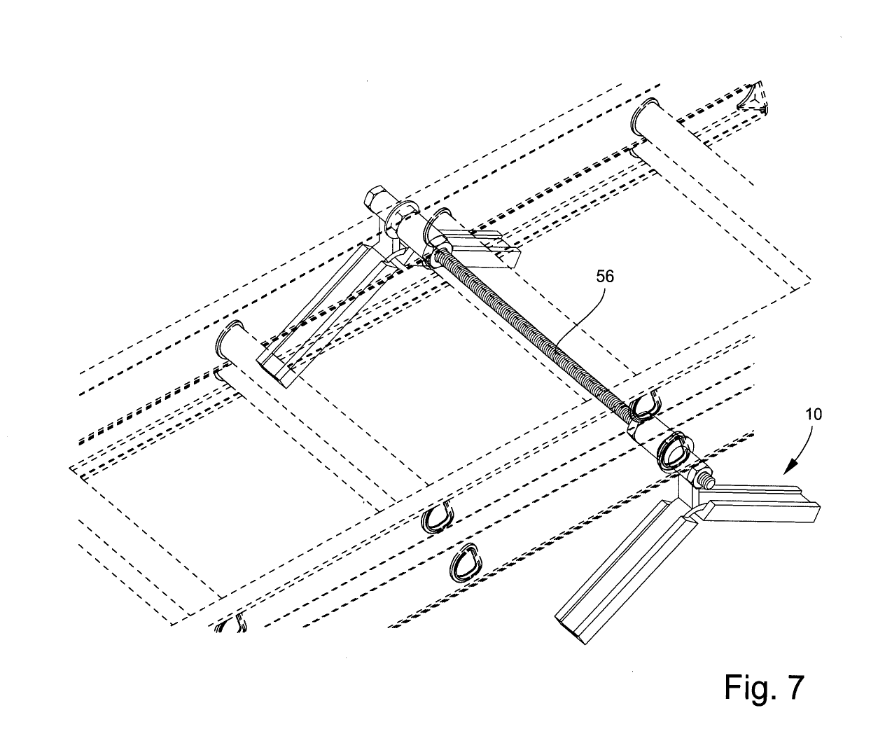

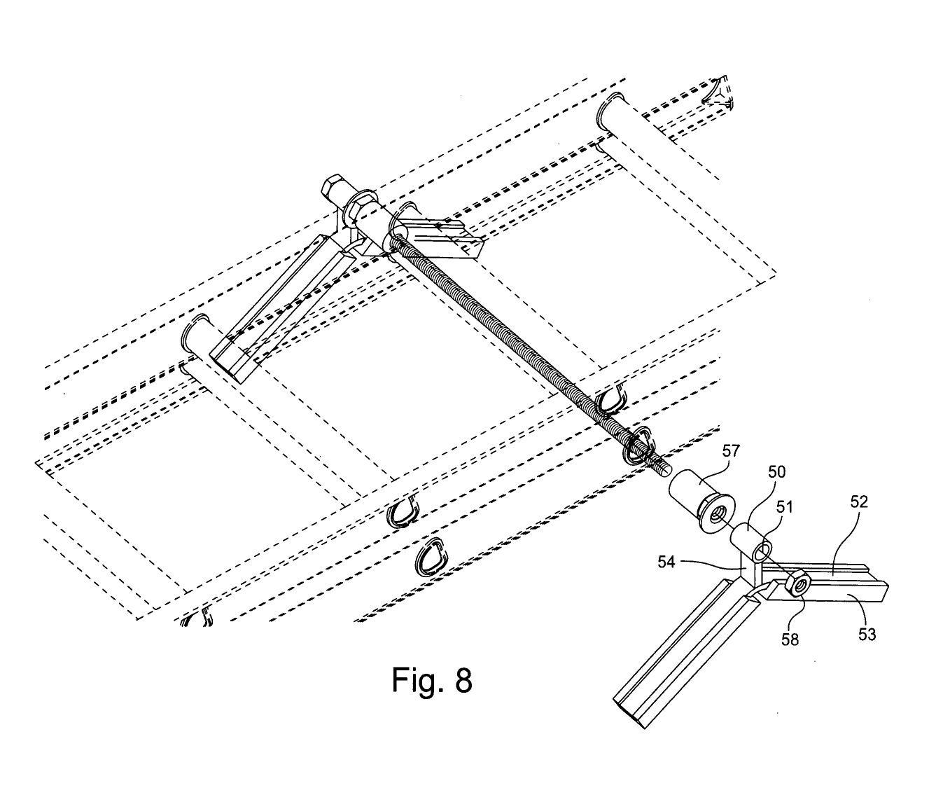

In a second embodiment, illustrated in FIGS. 6-8, each unit 10 comprises a unit body 50 having a pivot aperture 51. Pivotally attached to the unit body 50 are at least one, preferably two unit arms 52. Each unit arm 52 is further provided with a cushion 53.

In a preferred version of the second embodiment the unit arms 52 are attached to the unit body 50 by a spacing segment, or arm body, 54. It is understood that the unit body 50 may be sized and shaped large enough to dispose of the spacing segment 54 or the spacing segment 54 may be an integral part of the unit body 50 and still fall within the scope of the present invention.

In the preferred version of the second embodiment, each kit also includes an axle rod 56, two hub elements 57, and two securing mechanisms, such nuts 58.

In use the axle rod 56 is inserted through the barrel of a ladder step, the each hub element 57 is threaded onto the axle rod 56, one at each end of the axle rod 56, leaving a portion of each end of the axle rod 56 exposed beyond the hub elements 57. The unit bodies 50 are placed onto the axle rod 56 by inserting each end of the axle rod 56 through the pivot aperture 51 in each unit body 50, respectively. A nut 58 is then threaded onto the remaining end of the axle rod 56 thereby pivotally securing the units 10 to the ladder 1.

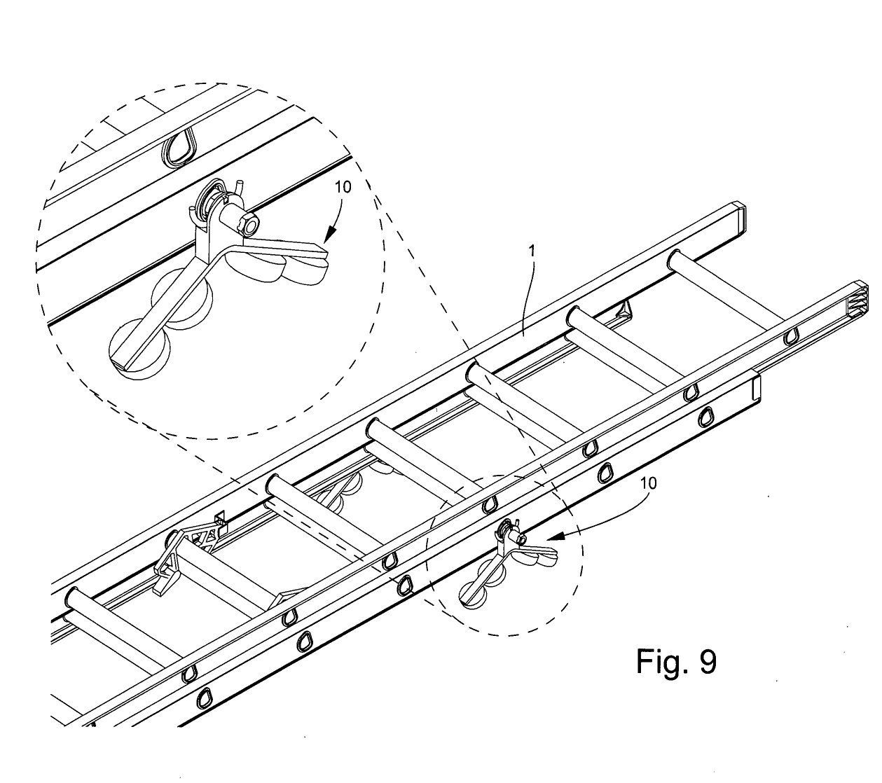

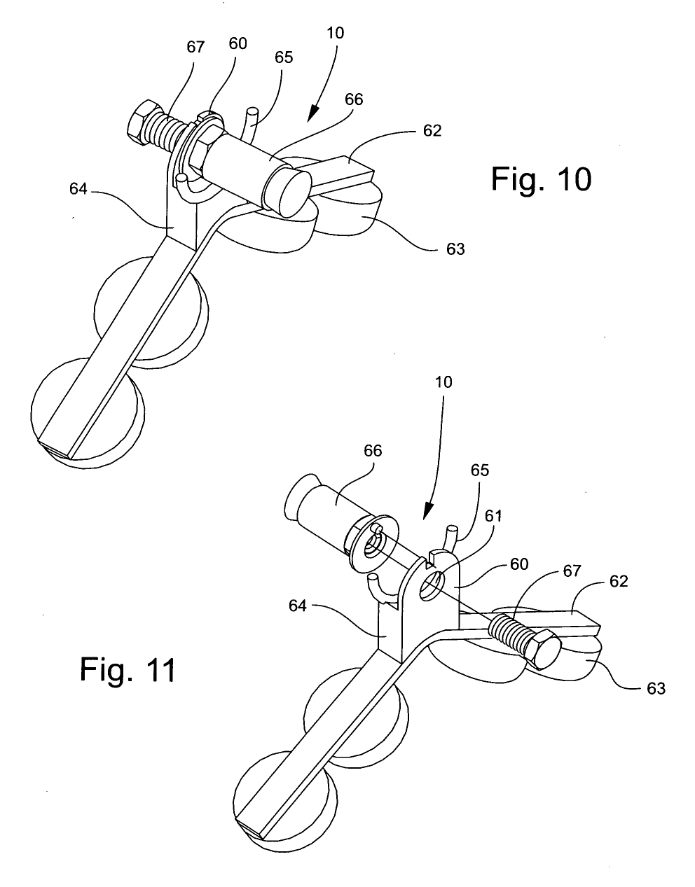

In a third embodiment, illustrated in FIGS. 9-11, each unit 10 comprises a unit body 60 having a pivot aperture 61. Attached to the unit body 60 are at least one, preferably two unit arms 62. Each unit arm 62 is further provided with a cushion 63.

In a preferred version of the third embodiment the unit arms 62 are attached to the unit body 60 by a spacing segment 64. It is understood that the unit body 60 may be sized and shaped large enough to dispose of the spacing segment 64 or the spacing segment 64 may be an integral part of the unit body 60 and still fall within the scope of the present invention. Further, the preferred version of the third embodiment includes a curved pivot guard 65 coaxial with the pivot aperture 61 and laterally spaced away from the pivot aperture 61.

In the preferred version of the third embodiment each kit also includes a pivot insert 66 and pivot pin or pivot bolt 67 for each unit body 60. Preferably the pivot insert 66 is a threaded insert, such as an expanding threaded bolt or pin insert. Further, preferably the pivot pin 67 is a threaded pin or bolt that mates with the threaded insert.

In use a pivot insert 66 is inserted into the barrel of a ladder step, a unit body 60 is inserted in the space between the unit body 60 and the curved pivot guard 65 and aligned adjacent to the pivot insert 66 such that the pivot aperture 61 is coaxial with the pivot insert 66. The pivot pin 67 in then inserted through the pivot aperture 61 and mated with the pivot insert, such as by threading the two together, thereby securing the threaded insert 66 into the ladder step barrel and providing a pivot axis about which the unit body 60 may rotate.

The preferred embodiment of the invention is described above in the Drawings and Description of Preferred Embodiments. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

What is claimed is:

1. A kit for securing ladders to a vehicle comprising at least two units, each unit comprising a body with a pivotally attached arm unit, wherein each unit is adapted to be secured to a portion of a ladder.

2. The kit according to claim 1 wherein each arm unit comprises an arm body, with a pivot aperture, and two attached arms.

3. The kit according to claim 2 wherein the included angle between the two attached arms is 120°.

4. The kit according to claim 1 wherein each body comprises a generally U shaped body comprising a base plate and first and second generally parallel side plates the base plate.

5. The kit according to claim 4 wherein each body further comprises a threaded aperture located in a generally central position in the first side plate and a threaded bolt threaded through the threaded aperture.

6. The kit according to claim 5 wherein the body further comprises a small channel cut into the vertex of the base plate and the second side.

7. The kit according to claim 1 wherein each body further comprises a pivot aperture and the kit further comprises an axle rod and two securing mechanisms.

8. The kit according to claim 7 wherein the kit further comprises two hub elements.

9. The kit according to claim 1 wherein the each body further comprises a pivot aperture and the kit further comprises a pivot insert and a pivot pin.

10. A method for securing ladders to a vehicle comprising the steps of:
a) providing two units, each unit comprising a body with a pivotally attached arm unit;
b) attaching the two units to opposite sides of a ladder;
c) placing the ladder in the bed of a pick-up such that the pivotally attached arm units are in contact with the cab of the pick-up; and
d) securing the ladder to the pick-up to prevent unwanted movement.

11. The method according to claim 10 wherein each arm unit an arm body, with a pivot aperture, and two attached arms.

12. The method according to claim 11 wherein the included angle between the two attached arms is 120°.

13. The method according to claim 10 wherein each body comprises a generally U shaped body comprising a base plate and first and second generally parallel side plates the base plate.

14. The method according to claim 13 wherein each body further comprises a threaded aperture located in a generally central position in the first side plate and a threaded bolt threaded through the threaded aperture.

15. The method according to claim 14 wherein the body further comprises a small channel cut into the vertex of the base plate and the second side.

16. The method according to claim 10 wherein each body further comprises a pivot aperture and the kit further comprises an axle rod and two securing mechanisms.

17. The method according to claim 16 wherein the kit further comprises two hub elements.

18. The method according to claim 10 wherein the each body further comprises a pivot aperture and the kit further comprises a pivot insert and a pivot pin.
